(19) United States
(12) Patent Application Publication
(10) Pub. No.: US 2014/0304968 A1
(43) Pub. Date: Oct. 16, 2014

(54) TREE STAND TOOLS

(71) Applicants: Mark E. LaFleur, Troy, MI (US); Thomas W. Lowry, JR., Clawson, MI (US)

(72) Inventors: Mark E. LaFleur, Troy, MI (US); Thomas W. Lowry, JR., Clawson, MI (US)

(21) Appl. No.: 14/254,399

(22) Filed: Apr. 16, 2014

Related U.S. Application Data
(60) Provisional application No. 61/812,331, filed on Apr. 16, 2013.
(60) Provisional application No. 61/814,929, filed on Apr. 23, 2013.

(51) Int. Cl. A01M 31/02

(52) U.S. Cl. CPC A01M 31/02
USPC 29/428; 182/129

(57) ABSTRACT

An illustrative example device for use with a tree stand includes a beam that is configured to slide into engagement with a climbing stick. The beam supports at least one of a hoisting member or a gear support member. A hoisting member allows an individual to hoist a tree stand up into a tree with greater efficiency and stability. A gear support member provides a convenient place to situate hunting gear within reach when an individual is situated in a tree.

### CROSS-REFERENCE TO RELATED APPLICATIONS

This application claims priority to U.S. Provisional Application No. 61/812,331, which was filed Apr. 16, 2013, and U.S. Provisional Application No. 61/814,929, which was filed Apr. 23, 2013.

### BACKGROUND

Hunters often use a tree stand for situating themselves above ground. One of the challenges associated with using a tree stand is that an individual has to secure the tree stand in place up in a selected tree. Another issue faced by many hunters is how to situate their gear in the tree once up in the tree stand.

### SUMMARY

An illustrative example device for use with a tree stand includes a beam that is configured to slide into engagement with a climbing stick. The beam supports at least one of a hoisting member or a gear support member. A hoisting member allows an individual to hoist a tree stand up into a tree with greater efficiency and stability. A gear support member provides a convenient place to situate hunting gear within reach when an individual is situated in a tree.

Various features associated with disclosed example embodiments will become apparent to those skilled in the art from the following detailed description. The drawings that accompany the detailed description can be briefly described as follows.

### BRIEF DESCRIPTION OF THE DRAWINGS

FIG. 1 schematically illustrates an example device designed according to an embodiment of this invention.

FIG. 2 schematically illustrates the device of FIG. 1 in an assembly that includes a climbing stick.

FIG. 3 schematically illustrates another example device in an assembly that includes a climbing stick.

FIG. 4 schematically illustrates a method of installing a tree stand according to an embodiment of this invention.

FIG. 5 schematically illustrates selected portions of another example assembly.

FIG. 6 schematically illustrates selected portions of another example assembly.

FIG. 7 schematically illustrates selected portions of another example assembly.

FIG. 8 schematically illustrates selected portions of another example assembly.

FIG. 9 is a partially exploded view of selected features of the embodiment of FIG. 8.

FIG. 10 schematically illustrates selected portions of another example assembly. a feature of another example process for allocating cloud computing resources.

### DETAILED DESCRIPTION

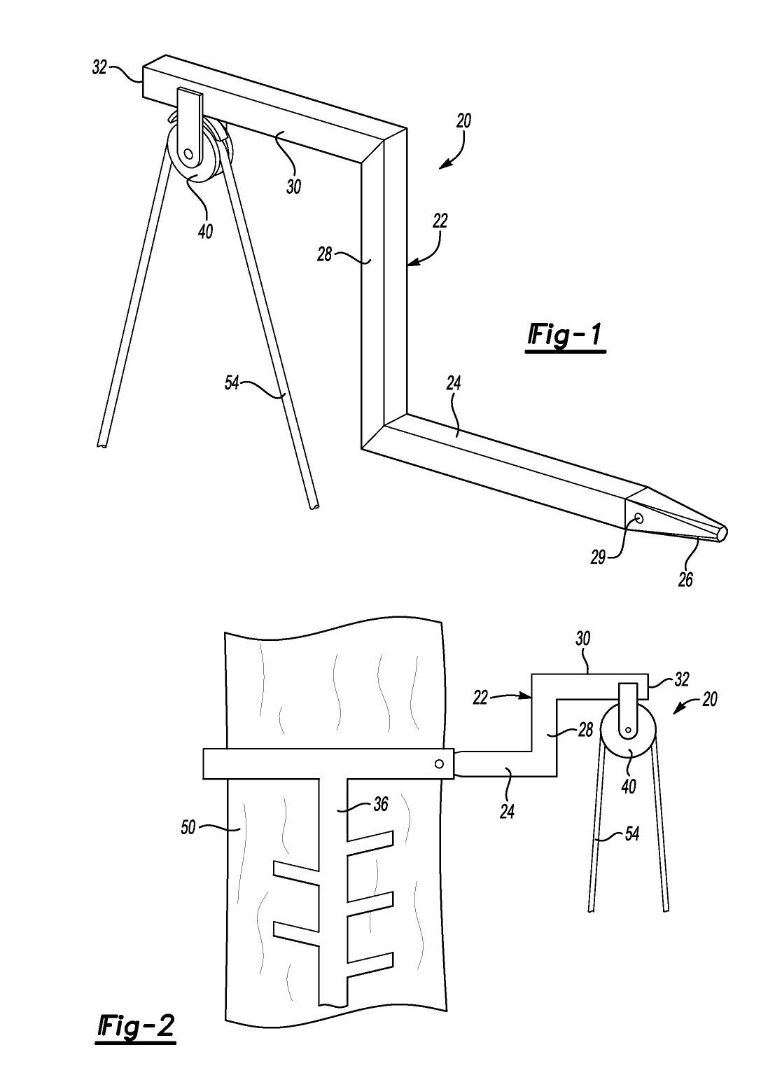

FIG. 1 shows one example tree stand hoisting device 20. In this example the device 20 comprises a beam 22 that has three portions. A first portion 24 extends from one end 26 of the beam 22 to a second portion 28 of the beam 22. The second portion 28 is oriented generally perpendicular to the first portion 24. A third portion 30 extends between the second portion 28 and a second end 32 of the beam 22. The third portion 30 is generally parallel to the first portion 24.

The end 26 of the beam 22 in this example is configured to slide into engagement with and be secured to a correspondingly shaped portion 34 of a climbing stick 36, such as the climbing stick partially shown in FIG. 2. In the case of FIG. 2, a top T-bar is selected as the portion 34 of the climbing stick 36. In some examples, it may be possible to slide the device 20 into engagement with a step or rung of the climbing stick 36.

The example beam 22 has a generally rectangular cross-section. The portion of the climbing stick 36 that the beam engages also has a rectangular cross-section. Other embodiments include different cross-sections.

A hole 29 is provided on the first portion 24 for receiving a pin or post that may also be received through a correspondingly sized hole in the climbing stick. The pin or post received in the hole 29 provides additional security for maintaining the device 20 in sufficient engagement with the climbing stick 36.

A hoist member 40, such as a pulley wheel, is supported near the second end 32 of the beam 22. The hoist member 40 facilitates hoisting at least a tree stand up into the tree 50. The hoist member 40 may also be used to hoist gear up into the tree 50.

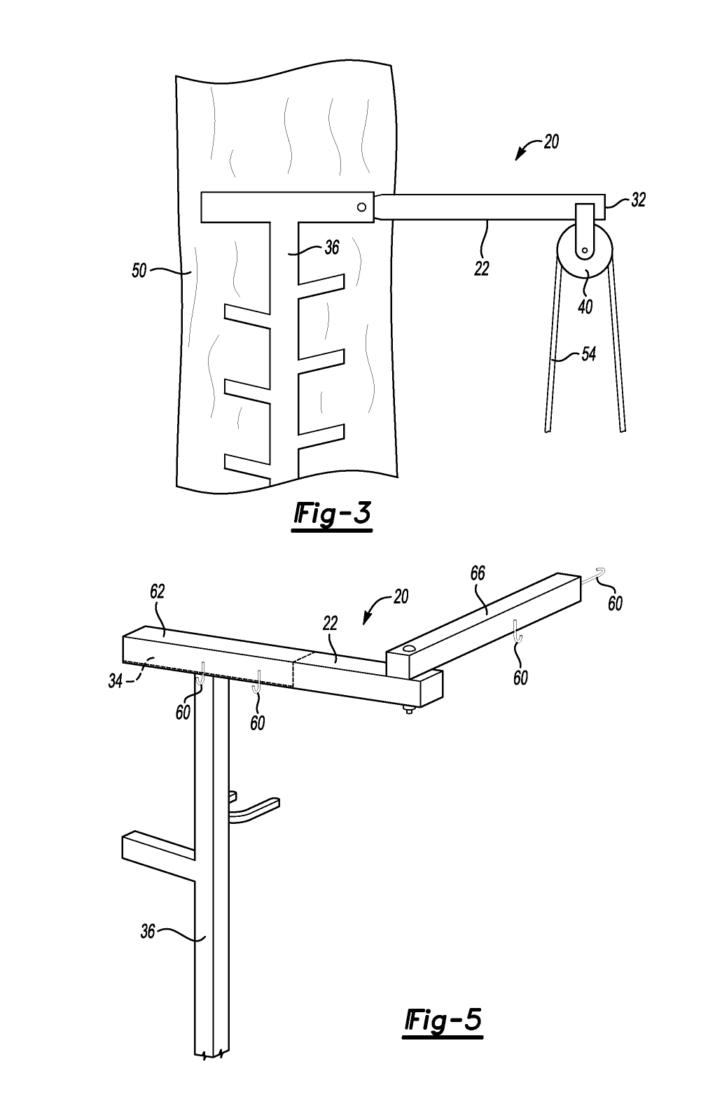

FIG. 3 shows another example tree stand hoisting assembly including a device 20 associated with a climbing stick 34 and up in a tree 50. In this example, the beam 22 is straight so that the first portion 24, the second portion 28 and the third portion 30 are all parallel to each other. One feature of the example of FIG. 1 compared to the embodiment of FIG. 2 is that the former allows for situating the hoisting member 40 above the highest portion of the climbing stick, which can make it easier for an individual to manipulate a hoisting rope 54 for pulling the tree stand or gear up to the height of the individual even when the individual is near or at the top of the climbing stick 36.

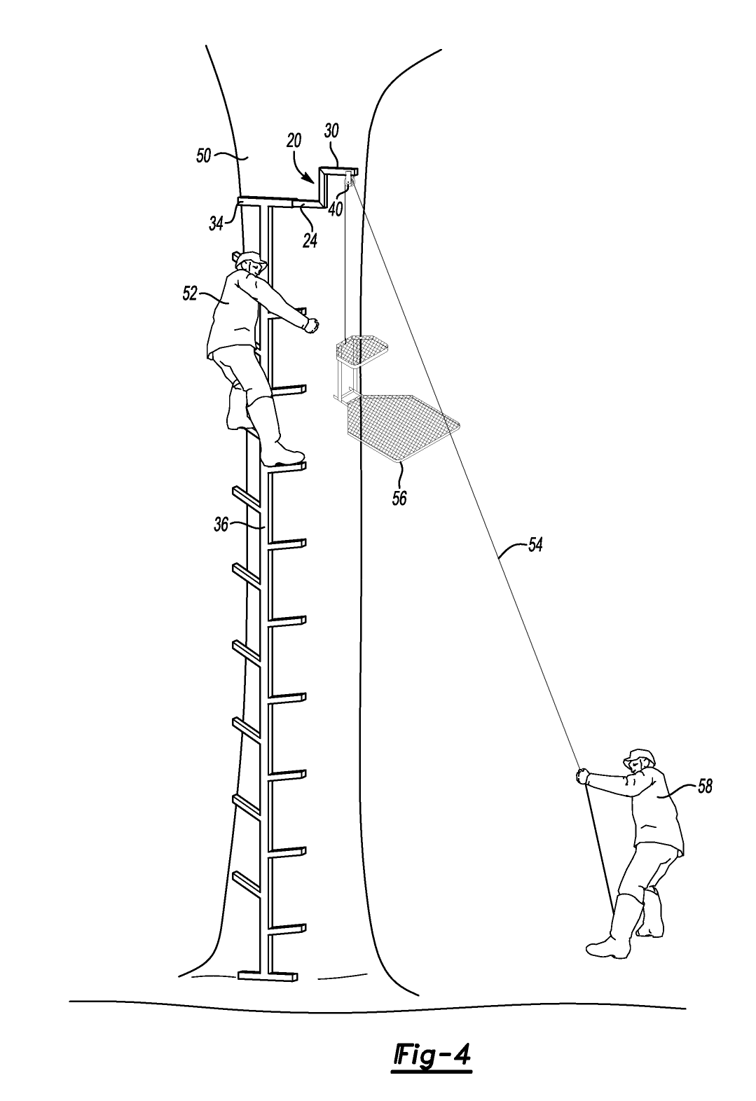

FIG. 4 schematically shows an example use of the embodiment of FIG. 1. In this case, a climbing stick 36 has been secured against a tree 50 in a known manner. An individual 52 ascends the climbing stick 36 into the position shown near the top of the climbing stick. If the beam 22 has not already been secured to the climbing stick 36, such as prior to situating the climbing stick 36 against the tree 50, the individual 52 slides the beam 22 into place at a convenient time, such as when the individual is in the position shown in FIG. 4. For example, inserting the end 26 into one side of the T-bar at the top of the climbing stick 36 provides a secure placement of the device 20 relative to the individual 52 in the tree.

With the device 20 coupled to the climbing stick 36 the individual 52 may pull on a hoisting rope 54 to pull a tree stand 56 up into a selected location in the tree 50 where the individual 52 may secure the tree stand 56 to the tree 50 in a known manner. In FIG. 4 another individual 58 provides assistance for hoisting the tree stand 56 into the desired location although two people are not required to enjoy the benefits and efficiencies provided by the device 20.

FIG. 5 shows an example gear supporting embodiment. The beam 22 in this example includes a plurality of gear supports 60, such as hooks, that provide a convenient location for hanging hunting gear near the tree stand 56 in the tree 50. The example of FIG. 5 includes a sleeve portion 62 on the one end 26 of the beam 20 that slides over and onto a portion 34, such as the top T-bar, of the climbing stick 36 (as shown by the broken lines in FIG. 5). This example includes a pivoting beam member 66 that is selectively moveable relative to the beam 22 to position a gear support 60 or the gear (not shown) that is on the gear support 60 in a convenient location where an individual can have easy access to it while in the tree stand 56.

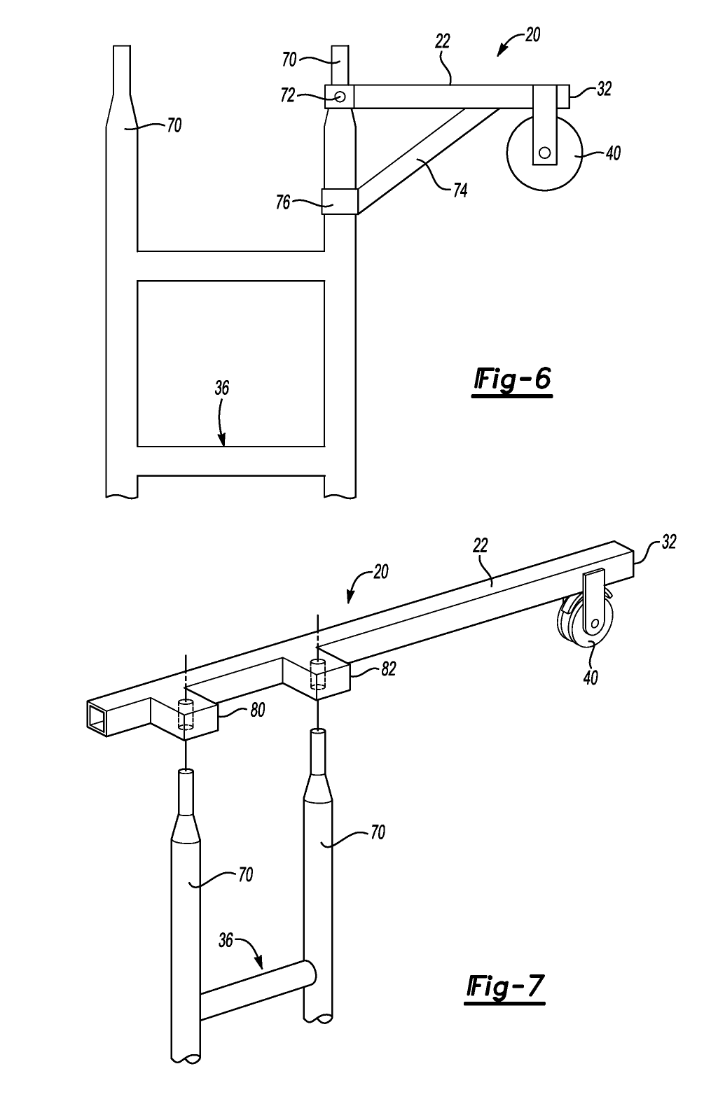

FIG. 6 illustrates another embodiment in which the climbing stick 36 has side rails 70 upon which the device 20 may be situated. In this example, the beam 22 includes a collar 72 that is received over one of the side rails 70. An angled support member 74 extends beneath the beam 22 to a position where the support member 74 may engage the climbing stick 36 for increased stability. The example of FIG. 6 includes a collar 76 near an end of the angled support member 74. The collar 76 is slid onto or received over the side rail 70 prior to the collar 72 as the device 20 is lowered into the position shown in FIG. 6.

FIG. 7 shows another example embodiment. In this example the climbing stick 36 includes side rails 70 and the device 20 includes collars 80 and 82 situated on the beam 22 such that the collars 80 and 82 can be received onto the side rails 70. Having two collars received over the side rails, respectively, prevents the beam 22 from tipping when a load is supported by the hoisting mechanism 40. Instead of collars 80 and 82, the beam 22 may include openings through which the side rails 70 are received.

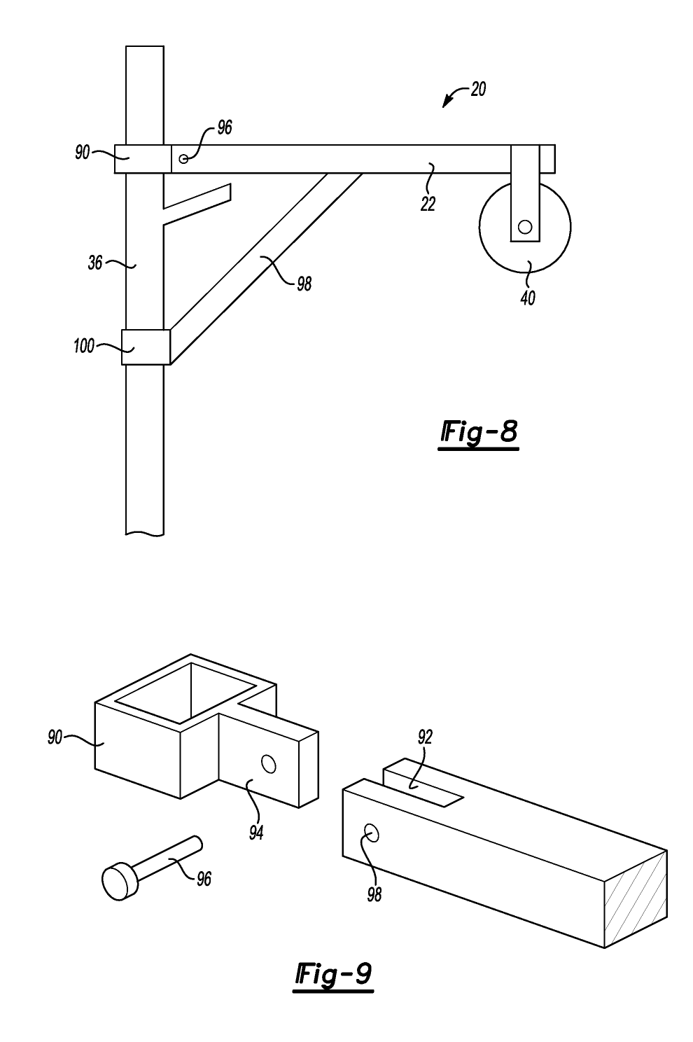

FIG. 8 shows another example device 20 that includes a collar 90 configured to be received over a vertical portion of a climbing stick 36. The beam 22 includes a slot or channel 92 that is received over a tab 94 on the collar 90. A bolt 96 is received through holes in the beam 22 and the tab 94 to secure the beam 22 to the collar 90 while allowing the beam 22 to pivot relative to the collar 90 and the climbing stick 36. An angled support 98 includes an open channel 100 near an end of the support 98. The channel 100 is generally U-shaped and received about the climbing stick 36 when the beam 22 is generally horizontal, which is a desired position for using the hoisting mechanism 40 to hoist a tree stand into or out of a tree. The channel 100 is rounded for engaging a vertical member of a climbing stick 36 that has a rounded or circular cross-section. The channel 100 is squared for engaging a vertical member of a climbing stick 36 that has a squared cross-section.

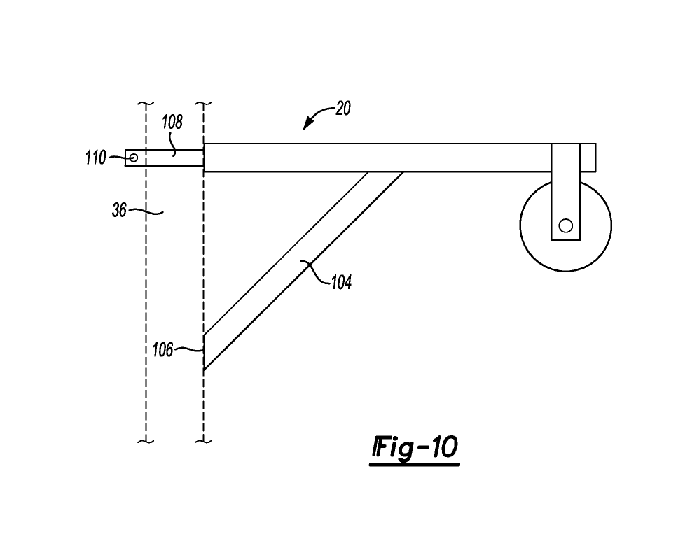

FIG. 10 shows another embodiment. In this example, the beam 22 includes an angled support member 104 that includes an end 106 configured to be received against a climbing stick 36. One end of the beam 22 comprises a tab 108 that is received in a slot or another correspondingly configured portion of the climbing stick 36. A hole 110 is configured to receive a pin or post 112 to secure the beam 22 in a desired position relative to the climbing stick 36.

The ability to slide a device 20 into engagement with a climbing stick as shown in the figures allows an individual to place a tree stand within a tree and to arrange gear while in a tree stand more efficiently and more easily than was otherwise possible. There is no need to penetrate the surface of the tree 50 with any screws or nails, which reduces the effort required and preserves the tree. Using a hoisting device as illustrated can significantly reduce the time and effort required to get a tree stand properly situated in a tree.

Different features are associated with different examples described above. Those features are not necessarily limited only to the embodiment with which they are disclosed. In other words, one or more features of one embodiment may be incorporated into or combined with one or more features of another embodiment.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A device for use with a tree stand, the device comprising:
a beam including a first portion configured to move into engagement with a climbing stick; and
a hoisting mechanism supported by the beam at a position spaced from the first portion, the hoisting mechanism being configured to facilitate hoisting a tree stand.

2. The device of claim 1, wherein the hoisting mechanism comprises a pulley.

3. The device of claim 1, wherein the first portion of the beam is configured to be at least partially received into a portion of a climbing stick.

4. The device of claim 3, wherein the first portion is tapered and includes a smaller outside dimension near an end of the beam and a larger outside dimension closer to a central portion of the beam.

5. The device of claim 3, comprising a pin and wherein the first portion comprises an opening configured to receive the pin when the first portion is received into the portion of the climbing stick, the pin being operative to secure the beam in a selected position relative to the climbing stick.

6. The device of claim 1, wherein the first portion of the beam is configured to be received over a portion of a climbing stick.

7. The device of claim 1, wherein the beam includes a second portion adjacent the first portion;
the beam includes a third portion adjacent the second section;
the first portion is generally parallel to the third portion; and
the second portion is generally perpendicular to the first portion and the third portion.

8. The device of claim 1, wherein the first portion of the beam is at least partially configured to slide into engagement with the climbing stick.

9. The device of claim 1, wherein the first portion of the beam comprises at least one collar.

10. The device of claim 1, wherein
the collar comprises a tab; and
the beam comprises a channel that is received at least partially over the tab.

11. The device of claim 1, wherein the first portion of the beam comprises a tab.

12. The device of claim 1, comprising at least one gear support member on the beam.

13. The device of claim 1, wherein the beam comprises one section that is pivotally moveable relative to another section of the beam.

14. The device of claim 1, comprising
an support member extending from the beam at an oblique angle, the support member having an end configured to be received against the climbing stick.

15. The device of claim 14, wherein the end of the support member comprises a channel that is receive about a portion of the climbing stick.

16. An assembly, comprising:
a climbing stick having a plurality of steps;
a beam having a portion engaging the climbing stick, one end of the beam being situated away from the climbing stick; and
a hoisting mechanism supported by the beam near the one end of the beam.

17. The assembly of claim 16, wherein the beam comprises a portion in sliding engagement with the climbing stick.

18. The assembly of claim 17, wherein the portion of the beam comprises at least one of
a tapered end,
a collar, and
a tab.

19. The assembly of claim 16, comprising at least one gear support hook on the beam.

20. A method of installing a tree stand in a tree, comprising the steps of:
sliding a device into engagement with a climbing stick, wherein the device comprises a beam and a hoisting mechanism supported by the beam;
situating the climbing stick against a tree;
climbing the climbing stick;
using the hoisting mechanism to hoist the tree stand to a selected height; and
securing the tree stand to the tree.
